(19) United States
(12) Patent Application Publication
(10) Pub. No.: US 2019/0114565 A1
(43) Pub. Date: Apr. 18, 2019

(54) CLASS SCHEDULER

(71) Applicant: Ji Hyoung Kang, Bucheon-si (KR)

(72) Inventor: Ji Hyoung Kang, Bucheon-si (KR)

(21) Appl. No.: 15/782,879

(22) Filed: Oct. 13, 2017

(51) Int. Cl. G06Q 10/06; G06Q 10/10; G06Q 50/20

(52) U.S. Cl. CPC G06Q 10/06311; G06Q 50/205; G06Q 10/109

(57) ABSTRACT

Disclosed is a class scheduler. The disclosed class scheduler is configured to allow long-time class sections (A, B, C, D) having a long class hour and short-time class sections (a, b, c, d) having a relatively short class hour to form a set in a certain class hour zone of each day so as to allow any one of the upper-case section or the lower-case section of a certain set to be selected, enabling the subjects to be efficiently organized.

### TECHNICAL FIELD

The present invention relates to a class scheduler capable of effectively assigning a class schedule for one week in consideration of the characteristics of each subject, thereby improving the learning efficiency.

### BACKGROUND

Generally, students in the high schools of the United States may select subjects they want to attend under the conditions approved by the school.

Taking a conventional schedule of a certain school as an example, shown in FIG. 1, it is divided into sections A to H, and each section has a total of 190 minutes of class, and meets four times a week. Teachers of each subject plan to take several sections among A to H to lecture. Here, each student is scheduled individually, and subjects are appropriately assigned into each section so that a student can take those subjects he or she desires to take. However, in a conventional class schedule, the class hour for each subject is uniformly set for 40 to 55 minutes, failing to consider the characteristics of each subject.

For example, in the case of math class which requires high concentration, when the class is prolonged, the concentration may be deteriorated. Therefore, it is better to limit the class length to 50 minutes. However, in the case of the art (or English and experimental science) class, it is advantageous to lengthen the class and give sufficient time because when the class time is too short, the class is often finished before the artwork is completed. It is necessary to increase the learning efficiency by organizing the class hour considering these matters.

### SUMMARY

The present invention is to solve the above-mentioned conventional problems, and the main object of the present invention is to provide a class scheduler capable of effectively assigning subjects to a weekly class schedule in consideration of characteristics of each subject. Subjects such as art, English, and experimental science are effective to have a long class hour while other subjects such as math are effective to have a short class hour due to the need for high concentration. Taking these characteristics of each classes into concentration, institutions can improve their students' learning efficiency.

Problems to be solved by the present invention are not limited to the above-mentioned problems, and other problems not mentioned may be clearly understood by one of ordinary skill in the art from the following description.

To improve the problem of conventional scheduler, the present invention aimed to effectively assign a weekly class schedule according to characteristics of each subject. The class scheduler is configured to merge long-time class sections (A, B, C, D) which are designed to have long class hours, and short-time class sections (a, b, c, d) which are designed to have relatively short class hours to form a set in a certain class hour zone of each day, thereby allowing to select among the certain sets of an upper-case section and a lower-case section.

Preferably, the class scheduler further includes allowing each of lunchtime class sections (a1,a2)(b1,b2)(c1,c2)(e1,e2) having a class hour immediately before or after lunchtime to form a set, thereby enabling to select one of sets of each lunchtime class section.

Preferably, the long-time class sections (A, B, C, D) may have a class hour of 65 or 70 minutes, and the short-time class sections (a, b, c, d, e, f, g) always have a class hour of 50 minutes.

According to the present invention, the class scheduler may select a long-time class section for subjects such as an art which requires a long class hour, and select a short-time class section for subjects such as math which requires a short class hour due to the need for high concentration. Thus, the class scheduler can assign a class hour appropriately according to the characteristics of subjects, and thereby improve the teaching efficiency and learning efficiency.

### BRIEF DESCRIPTION OF THE DRAWINGS

FIG. 1 is a view illustrating an embodiment of a conventional class scheduler.

FIG. 2 is a view illustrating an embodiment of a class scheduler according to the present invention.

### DETAILED DESCRIPTION OF THE DISCLOSURE

The present invention is not limited to embodiments described herein but may be embodied in other forms. Rather, the embodiments disclosed herein are being provided so that this disclosure will be thorough and complete, and will fully convey the concept of the present invention to one of ordinary skill in the art. Like reference numerals designate like elements throughout the specification. Meanwhile, terms used in the present specification is for the purpose of describing the embodiments and are not intended to limit the present invention. In the present specification, a singular form includes a plural form unless otherwise specified in the context. “Comprises” and/or “comprising” used herein does not exclude the presence or addition of one or more other components, steps, operations, and/or elements to the stated components, steps, operations, and/or elements.

Hereinafter, preferred embodiments of the present invention will be described in detail with reference to the accompanying drawings.

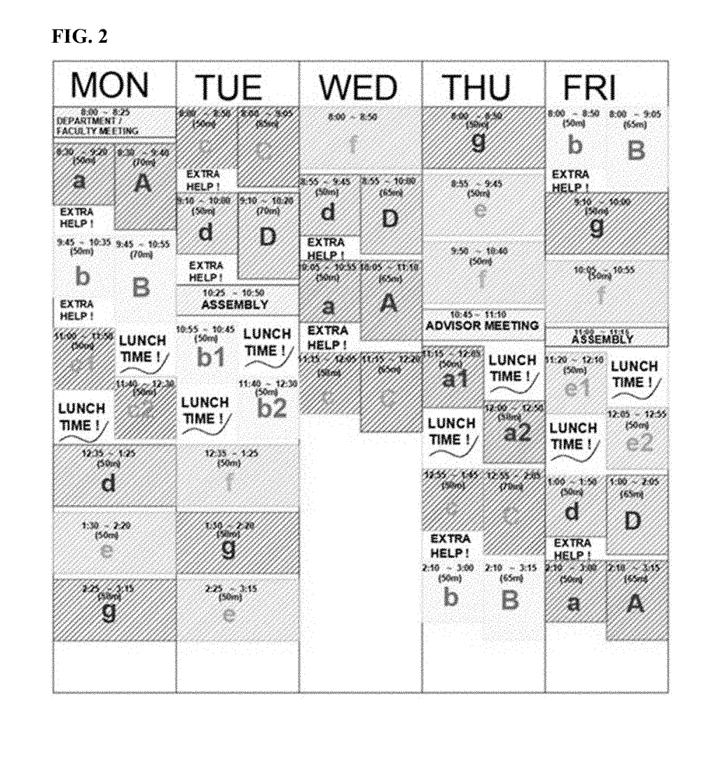

Attached FIG. 2 is a view illustrating one embodiment of a class scheduler according to the present invention.

Referring to FIG. 2, the class scheduler according to the present invention is a class schedule capable of selectively setting a class hour to set a class hour of a certain subject longer or relatively shorter according to characteristics of subjects or other reasons for a weekly class schedule.

Specifically, the class scheduler is configured to allow long-time class sections (A, B, C, D) having a long class hour and short-time class sections (a, b, c, d) having a relatively short class hour to form a set in a certain class hour zone of each day, thereby allowing either an upper-case section and a lower-case section of a certain set to be selected.

In the case of an art subject, a class is often finished before the work is finished properly, so it needs enough class hours. In the case of a mathematics subject, since it is a subject that requires high concentration, the teaching efficiency may be decreased due to deterioration of concentration if the class hour exceeds 50 minutes. Therefore, it is desired to set a class schedule in consideration of these matters.

For example, it is effective to lengthen the class hour by 70 minutes/class, 3 times a week for English and to shorten the class hour by 50 minutes/class, 4 times a week for mathematics.

For subjects requiring a long class hour, as in section A, it is possible to set a total of 200 minutes of a class hour per week with 70-minute, 65-minute, and 65-minute units. In the case of subjects requiring a short and frequent class hour, as in section a (a1, a2), it is possible to set a total of 200 minutes of a class hour per week with four 50-minute units.

In other words, even if the total class hour for a certain subject is 200 minutes, a teacher may select a teaching manner that reduces the number of classes in a week by lengthening the class hour per session or a teaching manner that increases the number of classes in a week by shortening the class hour per session.

The section A has only been described above, but sections B, C, and D having a long class hour may be set in the same manner, and sections b, c, d, e, f, and g having a short class hour may also be set in the same manner.

Here, the section A and the section a are always assigned to the same time zone, and a student who takes a class in the section A will not be able to take a class in the section a. By bundling the section A and the section a like this manner, a student who takes a class set in section A only has to avoid classes set in section a, and a student who cannot take a class of a certain teacher's subject due to taking a class set in section a may select one among sections b, c, d, e, f, and g if he/she wants to take that class.

Describing a section A-a set as a first section on Monday by way of an example,

In a time of the section A and the section a, there will be several classes in each building and each classroom at the same time.

If the section A-a of a student named Julie is an English class of a teacher Emily, the student will take the English (section A) class from the teacher Emily in the first session on Monday, the third session on Wednesday, and a sixth session on Friday.

If a section B-b of the student is a mathematics class of a teacher Daniel, the student will take the mathematics (section b) class from the teacher Daniel in the second session on Monday, the third session on Tuesday, a sixth session on Thursday, and a first session on Friday.

Also, if the section A-a of a student named Nick is a chemistry class of a teacher Jack, Nick will take the chemistry (section a) class from the teacher Jack at the same section A-a time zone in which the student named Julie is taking the English class from the teacher Emily.

If Nick also wishes to take the English class from the teacher Emily, he may search the teacher Emily's class hour in sections B, C, and D and put it on his schedule.

In this way, all of the sections A-a, B-b, C-c, D-d, e, f, and g will have several classes respectively, and the classes may be assigned to students who want them, thereby completing a perfect class schedule that satisfies all students.

Meanwhile, taking a closer look at the schedule, after finishing section a class, there is about 25 minutes of an extra time until next class starts, the students may use this extra time as a question time.

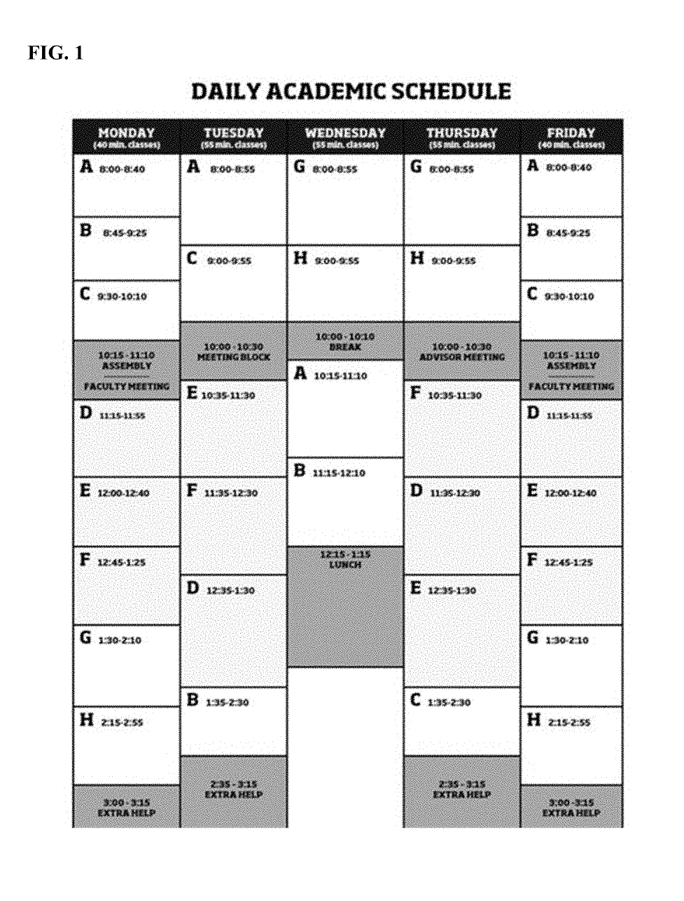

Referring to a conventional schedule in FIG. 1, it can be seen that there is the question time at the last hour of every day. However, in the case of the scheduler according to the present invention, it is possible to increase the learning efficiency since a time to ask a question is given immediately after the classes.

Further, in the case of section A, since there are only three classes during a week, either a section a1 (lunchtime class section) or a section a2 in the fourth session on Thursday, in which the section a class proceeds without the section A class may be utilized as the question time, and the lunchtime may also be adjusted naturally.

The class scheduler described above has an advantage of improving the learning efficiency by setting a schedule considering subjects requiring a long time such as English, art, experimental science, and also considering subjects requiring short concentration.

While the present invention has been described in detail with reference to specific embodiments, it is for the purpose of illustrating the present invention specifically, and the present invention is not limited thereto. It is apparent that changes and modifications may be made within the technical teaching of the present invention by one of ordinary skill in the art.

All of the simple changes and modifications of the present invention fall within the scope of the present invention, and the specific scope of protection of the present invention will be apparent by the appended claims.

What is claimed is:

1. A class scheduler for effectively assigning a weekly class schedule according to characteristics of each subject, the class scheduler is configured to allow long-time class sections (A, B, C, D) having a long class hour and short-time class sections (a, b, c, d) having a relatively short class hour to form a set in a certain class hour zone of each day, thereby allowing either the upper-case section or the lower-case section of a certain set to be selected.

2. The class scheduler of claim 1, wherein the long-time class sections (A, B, C, D) have a class hour of 65 or 70 minutes and the short-time class sections (a, b, c, d, e, f, g) have a class hour of 50 minutes.
